(19) United States
(12) Patent Application Publication
(10) Pub. No.: US 2008/0208633 A1
(43) Pub. Date: Aug. 28, 2008

(54) LOGICAL INTERFACE FOR MEDICAL RECORD DATA MINING

(75) Inventor: Girish Kumar Navani, Shrewsbury, MA (US)

Correspondence Address: POWELL GOLDSTEIN LLP, 901 NEW YORK AVENUE, N.W., 3RD FLOOR, WASHINGTON, DC, 20001-4413, US

(73) Assignee: ECLINICALWORKS LLC, Westborough, MA (US)

(21) Appl. No.: 11/831,118

(22) Filed: Jul. 31, 2007

Related U.S. Application Data
(60) Provisional application No. 60/891,837, filed on Feb. 27, 2007.

(51) Int. Cl. G06F 19/00

(52) U.S. Cl. 705/3

(57) ABSTRACT

In accordance with an embodiment, a logical interface for mining medical data records comprises a data processor for receiving input of a selection of criteria for a medical records query, a database of medical records, responsive to a query, for outputting patient medical record data responsive to the query, and a plurality of operations including a means of combining a first and second query and a means of providing medical data not meeting the first and second query. The query may utilize a plurality of filters among the following: demographics, vitals, laboratories, ICD codes, CPT codes, prescriptions, alerts, medical history, immunizations and encounters/visits among other filters. In one embodiment, the result of a series of queries may be output to a central database for various purposes including the identification of an outbreak of an epidemic in a geographic region. In reverse, an embodiment may comprise a patient portal for posting personalized patient alerts regarding, for example, medical risks associated with taking a given medication or having received a bad vaccination lot.

This application claims priority to U.S. Provisional Patent Application Ser. No. 60/891,837 filed Feb. 27, 2007, which application is incorporated herein by reference in its entirety.

### FIELD OF THE INVENTION

The invention relates to the technical field of data processing apparatus and computer software for providing a logical interface to mine medical patient records. As a result of the logical interface for mining patient data records, medical statistics may be gathered and published to a central database, patient letters may be generated automatically as patient reminders, and medical alerts and the like may be generated at a local or centralized location to patients via a secure patient portal. Moreover, the medical records data mining has application for many other purposes only limited by the imagination.

### BACKGROUND OF THE INVENTION

Electronic medical record (EMR) hardware and related software systems are known. In deed, the assignee of the present invention, eClinicalWorks, has been in the business of developing and offering for sale such systems for many years. U.S. Pat. No. 6,684,276 issued to Walker et al. describes a patient encounter electronic medical record system, method and computer product. The product includes pre-populated, diagnostic templates, selective, specialty-specific master databases and templates to achieve comprehensive, accurate and compliant medical documentation that captures patient data concurrently with a clinical patient encounter system. Referring to FIG. 6, for example, there is shown a series of patients 1-6 processed over time demonstrating a productivity flow. FIGS. 7A-7B provides a system process flow diagram including data entry. By way of example, FIG. 13A shows a “present history” of a “medial meniscus tear” for a 25 year old man. ICD (diagnosis) codes are shown in Table 2 for “pain knee” and the computer system 1201 may include special purpose logic devices. In the description of FIG. 11 is included a “drilldown logic feature” to output a screen of greater anatomical detail.

A patient-controlled medical information system and method are disclosed in U.S. Pat. No. 6,988,075 to Hacker. Patient medical records are centrally stored on a database that may be remotely accessed by patients. Referring to FIG. 1, there is shown a patient 101 who registers with a service to have their medical records stored electronically on a medical information database 110. In one embodiment, email may notify the patient of an impending appointment. With the patient's permission, the system can be used by a medical researcher.

Methods and apparatus for early detection of health-related events in a population are described by U.S. Pat. No. 7,024,370 to Epler et al. Sets of specific emergency room patient information may be captured from a subset of a population as the patient information is first electronically entered into an electronic medical record. For example, reference should be made to FIG. 2, step 11 and its attendant description. An alert may then be reported to a health official or government authority such as the Center for Disease Control (CDC).

Medical records, documentation, tracking and order entry are described by U.S. Pat. No. 7,076,436 issued to Ross et al. A feature of the '436 disclosure is data entry whereby dictation may be automatically input and parsed and incorporate prephrased text. A plurality of modules of the system include, for example, a security validation module for users, a tracking module, a master patient module, an advanced cardiac life support module, a laceration module, a utilities module, a transcript text analysis module and an interface module among other modules.

U.S. Pat. No. 7,092,891 describes a secure medical records maintenance system involving a first server for storing patient identification information by patient identification number and a second server for storing such records by medical record identification numbers. The latter may intentionally not be correlated to the former for security purposes without a special correlation table.

U.S. Pat. No. 7,133,937 to Leavitt relates to input devices for entering data into an electronic medical record. FIG. 3 illustrates a template and pen-like input device for data entry and, according to FIG. 4, may further incorporate condensed microphones. A stylus according to FIG. 5 may incorporate a microphone activation button and microphone into the stylus for also writing on a touchscreen.

A web-based data entry system and method of generating medical records is described by U.S. Patent Application Publication No. 2006/0116908 of Dew et al. Clinical, tree-like pathways are traversed as data describing a patient's condition is entered during a clinical examination of a patient. At a node, a physician may be prompted for additional health information to aid in the diagnosis/treatment. For example, per FIG. 3, an anatomical region leads to long bones, a right long bone, office x-rays, a contusion, no injury and follow-up, for example, leading to a “resolved” state or “not improving.”

A method, system, and computer-readable medium for providing a patient electronic medical record with an improved timeline is discussed in U.S. Patent Application Publication 2006/0265249 to Follis et al. Referring to FIG. 2, there is shown a Bill K. Jones, a 51 year old male and an associated date line display from 1990 through 2003. A number of sections appear on a y-axis, for example, documents, past surgical history, medical imaging, PSA/labs, medications and the like. FIGS. 27-61 illustrate exemplary user interface screens for creating office visit notes for inclusion in a patient's electronic medical record. Specific results, for example, of a urinalysis may be displayed per FIG. 82.

To the extent necessary for a proper understanding of aspects of preferred embodiments discussed subsequently herein, the above-identified United States patents and published applications should be deemed to be incorporated herein by reference as to their entire respective contents.

### SUMMARY OF THE INVENTION

In accordance with an embodiment, a logical interface for mining medical data records comprises a data processor for receiving input of a selection of criteria for a medical records query, a database of medical records, responsive to a query, for outputting patient medical record data responsive to the query, and a plurality of operations including a means of combining a first and second query and a means of providing medical data not meeting the first and second query. The query may utilize a plurality of filters among the following: demographics, vitals, laboratories, ICD codes, CPT codes, prescriptions, alerts, medical history, immunizations and encounters/visits (among other filters). In one embodiment, the result of a series of queries may be output to a central database for various purposes including the identification of an outbreak of an epidemic in a geographic region. In reverse, an embodiment may comprise a patient portal for posting personalized patient alerts regarding, for example, medical risks associated with taking a given medication or having received a given vaccination or course of treatment.

These and other features of the logical interface will become clear from reading the following detailed description of an embodiment with reference to the drawings.

### BRIEF DESCRIPTION OF THE DRAWINGS

FIG. 1 is a general system description depicting four functions including schedule, prescribe, chart and charge functions that may be provided by one or more electronic medical records computer software systems.

FIG. 2 shows a typical doctor's office system 201 which may include data input and output locations for medical patient data of a database managed by a plurality of data entry terminals, output devices and, for example, personal computers coupled to a main processor server and database. The system 201 may be redundant for disaster recovery purposes and maintained at a plurality of locations in a secure manner and in communication with other offices and one or more central locations.

FIG. 3 is a schematic block diagram of the functionality of the electronic medical records software of one embodiment showing a registry function and a plurality of exemplary data including demographic, vitals, laboratories, ICD, CPT, prescription, alert, medical history, immunization and encounters/visits which may be utilized as filters in a query/run subset/run subset (not) Boolean mining of the exemplary data.

FIG. 4 is a depiction of an EMR registry module of FIG. 3 showing available connectivity for outputting subset data in a secure manner for external purposes such as federal, state and private research purposes; alternatively, the EMR registry module may be accessed from such external agencies for, for example, confidential patient alerts.

FIGS. 5 represents a screen shot of a Vitals Button with “Migrate Vitals” button 501 and a plurality of logical interfaces—Save Queries, Run Subset (NOT), Run Subset and Run New which comprise a registry function.

FIG. 6 represents a screen shot for assessment notes, for example, for code 369.11, of a particular patient.

FIG. 7 represents a screen shot for CPT Codes.

FIG. 8 represents a screen shot for a CPT Groups (pop-up).

FIG. 9 represents a screen shot for selecting a Drug Class.

FIG. 10 represents a screen shot for a drug class (popup).

FIG. 11 represents a screen shot for selecting a prescription by Drug codes.

FIG. 12 represents a screen shot for drug codes popup.

FIG. 13 is a screen shot representing a short hand for providing durations such as 3D (3 days) or 2Y (2 years).

FIG. 14 is a screen shot for selecting assessments among ICD codes where a first step may comprise selecting an assessment category or group such as cardiology 1400.

FIG. 15 is a screen shot for selecting assessments among ICD Codes where alternatively a code such as 3 ^{rd} degree sunburn 1410 may be picked directly and not by category.

FIG. 16 is a screen shot representing an ICD Groups popup for Cardio, for example for cardiology 1400.

FIG. 17 is a screen shot representing a laboratories list which may include imagery.

FIG. 18 is a screen shot representing Lot Number Options for, for example, vaccines.

FIG. 19 is a screen shot representing what may be lower buttons, for example, new appointment button 1910 for scheduling a new appointment.

FIG. 20 is a screen shot for a Medical History list such as an abscess 2010.

FIG. 21 is a screen shot for a Save Registry Report for saving a report prepared using a logical interface for logically combining queries of a patient database 206.

FIG. 22 is a screen shot for Standard Buttons for the registry function showing the registry buttons save queries, run subset (not), run subset and run new.

### DETAILED DESCRIPTION OF EMBODIMENTS

Electronic patient medical record software is known for many purposes. For example, one may record patient appointments with doctors or other medical practitioners in one known system. In what will be referred to herein as a mid-office management system, medical history records data may be recorded into a patient database as a doctor interviews a patient. Laboratory test data, patient image data, treatment data and prescription data may be merged into a patient database from locations internal or external to the primary care provider's offices. Prescriptions may be coordinated with drug and medical device outlets, and patient billing and medical insurance requirements may be met through software interaction with a patient database and the like. In a system referred to herein as a back office management system, billing and insurance coordination is provided so that patients may be properly billed according to standard insurance coding.

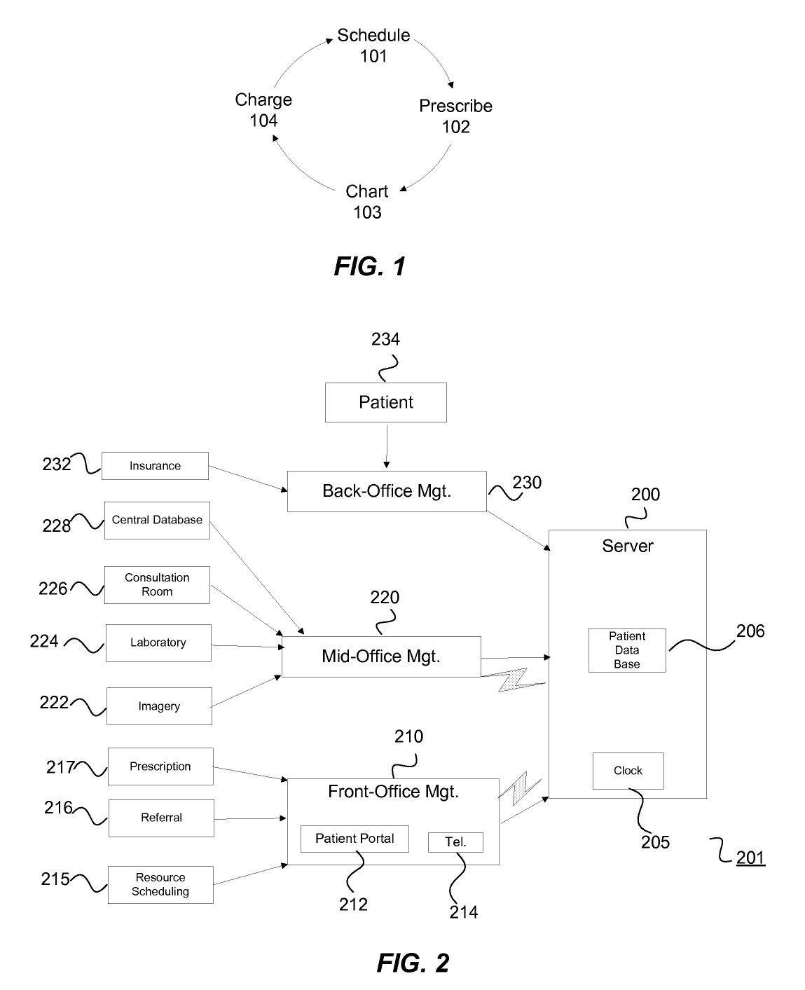

Referring to FIG. 1, there is shown a circular chart showing the purposes to which electronic medical records software systems have been applied. The chart comprises schedule 101, prescribe 102, chart 103 and charge 104. While a circular line is shown connecting these functions, it should not be inferred that these functions are performed in a particular order. In deed, a chart may be prepared with at least demographic information for a particular patient before a prescription is written for the patient. Nevertheless, the circular chart suggests that the process is iterative and must operate in real time. For example, illnesses, broken legs, telephone calls to schedule appointments, no shows for appointments and the like are real-time events which are unpredictable to the extent, for example, that known telecommunications busy hours are measurable phenomenon and so some prediction for patient calling patterns may be made.

Each purpose of schedule 101, prescribe 102, chart 103 and charge 104 will now be briefly explained. Schedule 101 refers to the start of a patient intake process that may be provided by electronic medical records software systems. A referral may be made by one group of doctors to another, for example, from a primary care provider to an orthopedic group in the event the patient of a primary care provider suffers a broken bone. The scheduling of an appointment may be precipitated not by a referring physician but by the patient themselves calling the primary care provider or a specialist's office. This scheduling software may also be referred to as front office management software and may be typically separately provided from other software functionality. The physician(s) or their assistant(s) may manage the physician's busy schedule electronically by creating, modifying and canceling appointments. The referral itself and the referring physician may be managed and their contact information and input collected. Access to patient records must typically be provided in a secure manner; patient privacy is very important. Via the input provided by the referral or directly by the new patient, patient demographics may be managed effectively. A patient appointment may be appropriately sized for the anticipated need. For example, the broken leg may have certain units of time associated with the initial consultation, diagnosis and prescription of certain imaging and potentially the scheduling of certain resources for surgery and the like. These all may be entered via scheduling software into a database. On the other hand, a complete physical for a patient may have longer or shorter units of time allocated to the physical which may include separate allocations of time required for in the office collection of blood and urine samples. The patient's in office physician visit may be monitored as individual time slots from the time the patient enters the office until the time the patient leaves.

In accordance with yet other functionality there may be a prescription functionality 102 associated with electronics medical records software. The physician may request x-rays, MRI scans and other imagery, blood testing, urinalysis and other tests, issue drug and medical device prescriptions and the like. There may be a refill charge billed to the patient, for example, in the instance of a requested refill if connected to a charge functionality 104. The results need to be received and merged with the patient records database. As suggested above, sample collection such as blood and urine may be collected during the visit, and the visit scheduled to allow sufficient time for collection. The laboratory result of analysis may be performed locally, for example, if the physician group comprises a hospital or office with internal laboratory facilities or the laboratory or imaging work may be performed elsewhere.

During the patient visit, there is a charting functionality 103 that may be associated with electronic medical records software. Charting may occur via a wireless 802.11 LAN or MAN. The physician or other care provider, at a patient meeting or during the office visit, may create or update the chart and the time of service from start time to end time for the portion of the appointment for chart consultation recorded. For example, the patient may be taken to a consultation room from a reception area. The physician may bring a PocketPC or TabletPC, a smaller iPhone, personal data assistant (PDA or other portable wireless device) with them to meet the patient in the consultation room. The physician or other care provider may directly enter chart such as demographic and diagnostic data, vitals such as temperature, blood pressure and the like into an electronic patient chart via a personal computer or the wireless device and the time of day and date recorded automatically.

In deed, the maintenance of an electronic patient record and chart may be referred to as a mid-office management computer software system, designed to permit the physician, nurse or other care provider access to and permission to input demographic, prescription, test, treatment and other patient data from the doctor's office, hospital or from their home or from the patient's home remotely via a secure remote data port or wireless data entry.

The fourth functionality of an electronic medical records software system may be a charge function 104. This function may also be referred to as a back-office management function of verifying patient eligibility, making insurance claims for patient visits, recording receipt of payments from insurance providers and patients and, for example, determining office visit co-payment. After the visit, claims may be electronically submitted to insurance carriers for the patient. The back-office component may communicate with payers to confirm eligibility of the patient to receive the care and treatment provided and thus permit feedback to the patient if or when the patient is unsatisfied with their bill or insurance coverage.

Many entities provide the component functionality of FIG. 1 in piece part. For example, front office management is provided by one software package running on one computer and mid-office management may run on a second computer while back-office management software runs on yet another computer. There is typically no integrated solution for electronic medical records (EMR) management. The functions of schedule, prescribe, chart and charge desirably are performed by one integrated software system implementation and include a data patient registry feature to query practice databases for highly specific patient information.

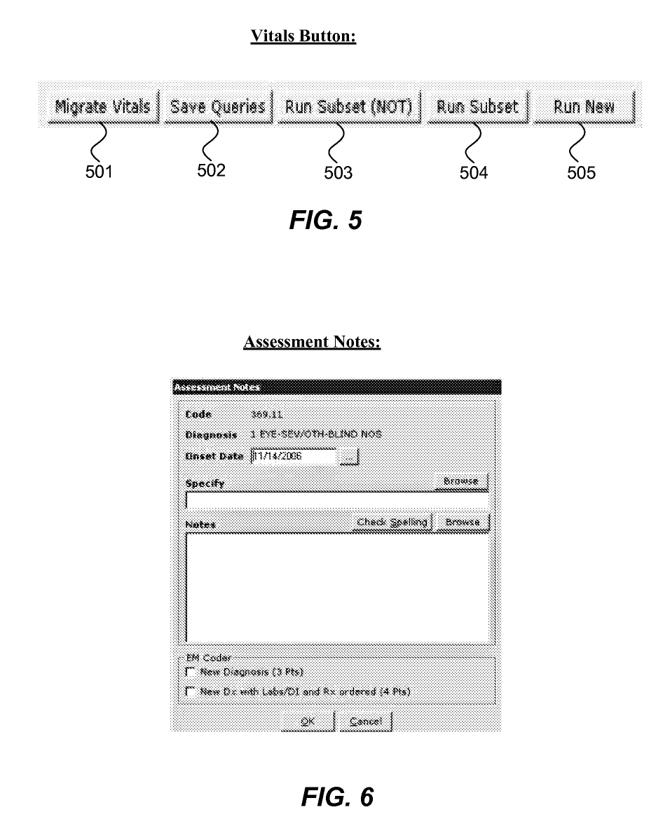

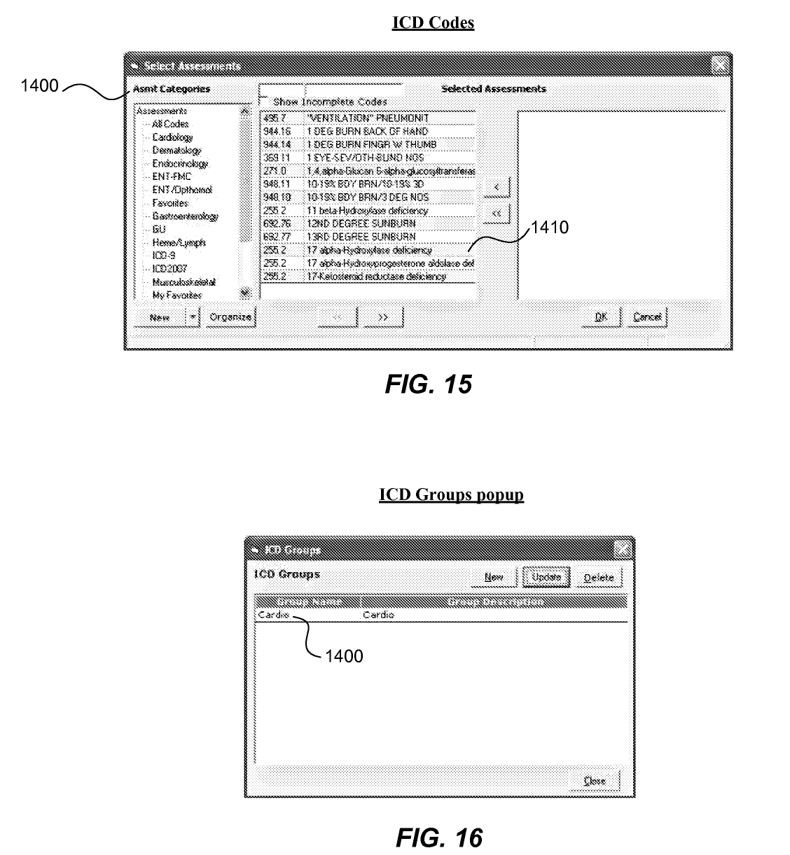

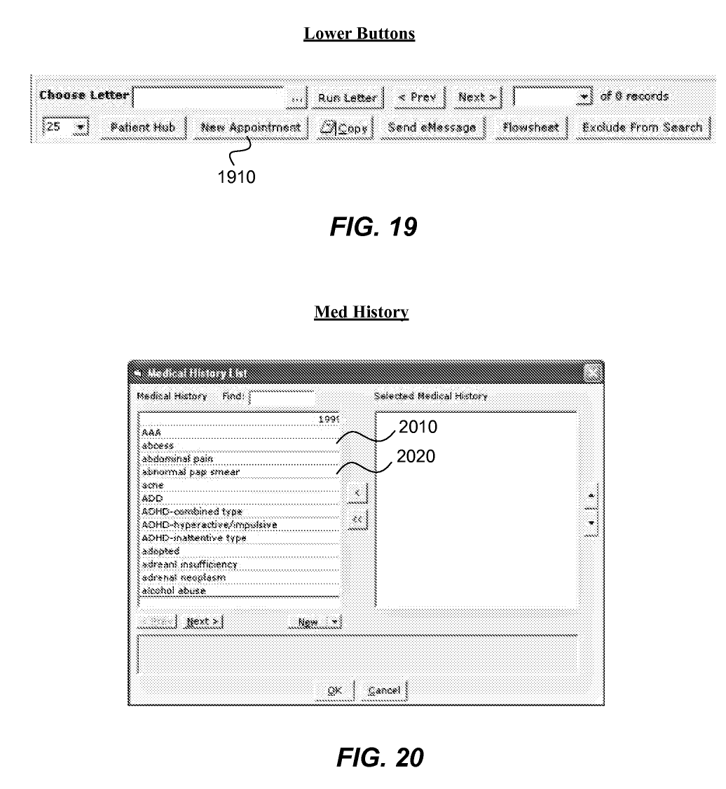

An embodiment of apparatus and a method for logically interfacing a patient medical record database will now be described with reference to FIGS. 1-4 and exemplary screen shots FIGS. 5-22 of electronic medical records (EMR) interface software according to one embodiment. The typical doctor's office maintains a front desk and reception area and an external interface to the patient, typically a telephone interface. FIG. 1, as described above, describes functionality performed within a doctor's offices from schedule 101 to charge 104. As explained above, the patient is involved at each level but, in the prior art, treated differently by different automated systems.

Referring to FIG. 2, a medical system 201 is shown with external interfaces to, for example, insurance 232, a patient 234, prescription 217, laboratory 224, imaging systems 222 and a referring physician 216 among other external entities.

There is shown a front office management module 210 of an electronic medical records computer software system application of a server 200 of an embodiment. Server 200 may be a Sun workstation server or a personal computer. Preferably, and for disaster recovery, the server 200 may be redundant but is shown as one unit for simplicity. The front office interface 210 to the patient occurs in many ways, typically by phone 214 and in person in a reception area of an office. In one embodiment, there is a secure patient portal 212 via the world wide web (the internet) whereby a patient may obtain even greater access than via telephone 214 as will be further explained below.

Also in FIG. 2, there are shown a mid-office management module 220 and a back-office management module 230 likewise serving as modules of computer software of server 200. The mid-office management module 220 is connected, for example, via wireless means, for example, I.E.E.E. 802.11 wireless LAN/MAN, to, for example, consultation rooms where a physician or other care provider may take and record medical history, vitals and the like as will be described herein for storage in database 206. Laboratory results (and time of day and date automatically recorded), chart data (from consultation room 226, for example) may be input from laboratory 224 and imagery input from imagery (Xray, MRI, etc) 222 to database 206 and clocked in real-time by time clock 205 by time and date.

Finally, in FIG. 2, there is shown a back-office management component 230. Typically, as the patient first enters the office, their insurance card is presented and may be entered at the front office management system 210 at initial patient contact. Behind the scenes, the back-office management system 230 may verify insurance coverage, co-pay procedures and the like with insurance company 232 and the patient may be requested to pay the appropriate co-pay amount and receive a well-documented bill showing a correct accounting of their status with their insurance carrier.

According to FIG. 1, the patient is involved in all phases of a process of medical service including scheduling 101, prescribing 102, charting 103 and charging 104. As can be seen from an embodiment according to FIG. 2, the patient is indeed involved in all phases of his processing through front office to back office, and the embodiment of FIG. 2 is an improvement over systems which treat front office scheduling as a separate computer software system from, for example, back office processing systems.

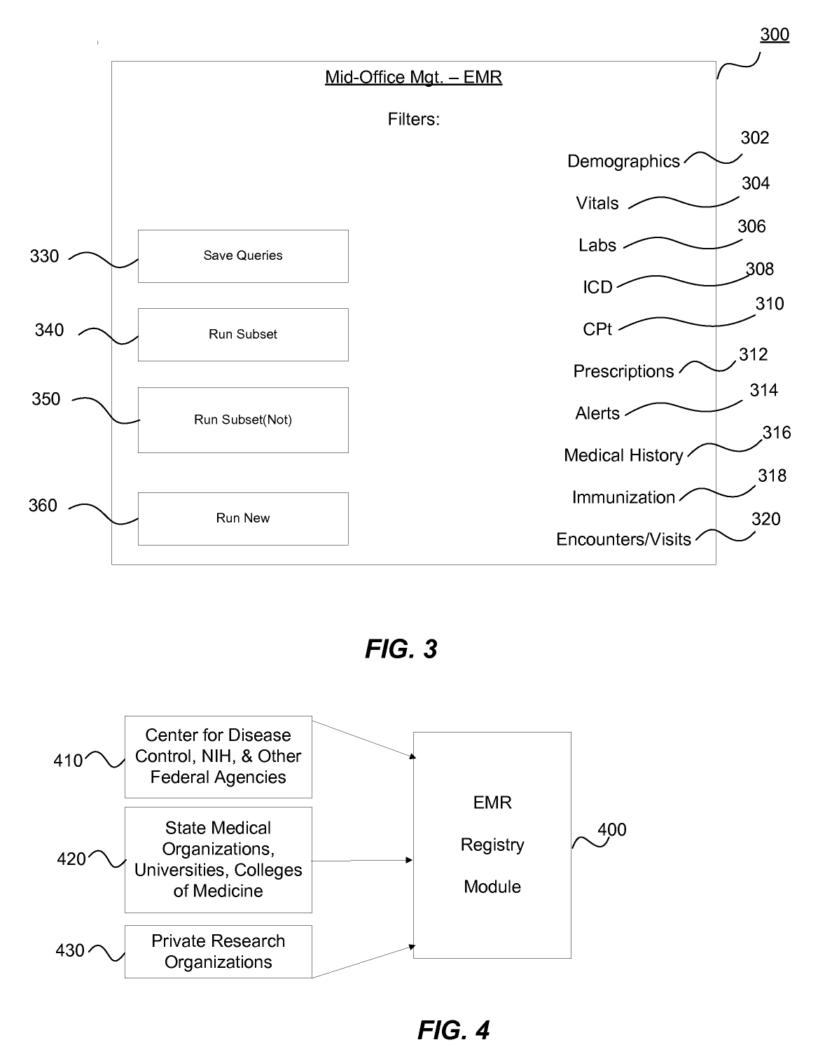

As soon as a patient calls a front office of a doctor's office, a receptionist takes the call via telephone 214 and begins interfacing with a system according to FIG. 2. As soon as a patient enters a doctor's office and signs in, the server 200 may record the time of day and date by clock 205 in database 206 so that the patient may be efficiently serviced during their visit and leave, hopefully, with a feeling of time well spent. FIG. 2 provides an integrated service embodiment for providing full services to a patient and, as will be described in greater detail in FIGS. 3-4, the medical records of a patient, in combination or singly, may provide a wealth of data which may be mined by the specialist or the primary care physician or by organizations external to either. In the specification, the primary care physician may be referred to as an example of a referring physician who in turn may refer a patient to a specialist for providing special services in accordance with a medical specialty. Such examples should not be deemed to be limiting in scope to other obvious possibilities such as when a cardiologist confers with another specialist such as a pediatrician on a diagnosis of a rare congenital heart defect of a child.

Referring again to FIG. 2, a front office module 210 of a medical record software system 200 may provide a patient portal 212 for, for example, an internet or world wide web interface to the patient 234. The patient 234 may securely access their own records after electronic signature or patient identification is satisfactorily provided to the system 201. Moreover, patient privacy is supported in all links between the patient and the database 206 or their access to any resources 215 or prescription scheduling 217. The patient 234 may schedule appointments or telephone consultation sessions or schedule resources through the patient portal 212 efficiently and securely. The patient 234 may order prescription refills, modify or cancel an existing appointment, typically with physician approval. In deed, through a wireless connection, the physician (not shown) may be alerted to the request for a refill and immediately grant the prescription refill with a practically immediate output facsimile or other notification to a pharmacy of the patient's choice via prescription link 217. Similarly, the patient 234 may interface with a front office management module 210 by telephone 214 and conduct much of the same business but utilizing the time and expense of a receptionist in a conventional manner. Consequently, a patient portal 212 can save a group of physicians time and money while providing increased access, for example, to resource scheduling 215 (make surgical room, laboratory or imaging appointments) not typically accessible through a receptionist.

A registry feature is provided via mid-office management 220 or other component of system 201 for mining database 206. Queries may identify, for example, certain vital symptoms that have been detected in a number of patients recently visiting a given office and provided via link 228 to a central database 228 for, for example, the Center for Disease Control. The Center for Disease Control, having collected data on the same symptoms from a number of offices in a given region, for example, may be able to identify the onset of an epidemic. In reverse, a medical alert may issue via central database 228 and be received at a mid-office component 220 or other component of system 201. A physician group may be alerted and, moreover, the front-office management component may issue patient alerts through the patient portal 212 or via an automatic telephone system 214 for repeatedly attempting to reach a patient 234 of the system 201.

Now, an exemplary mid-office management component 220 of FIG. 2 will be described in greater detail in FIG. 3 as mid-office management—electronic medical records (EMR) component 300 comprising registry functionality 330-360 and a plurality of database 206 components which may comprise query filters 302-320: demographics 302, vitals 304, labs 306, ICD 308, CPT 310, prescriptions 312, alerts 314, medical history 316, immunizations 318 and encounters/visits 320. These filters should be considered exemplary and other names for similar filters may be used or additional filters employed and considered within the scope of the described embodiment. Each of these may be formulated on a display screen of a computer or work station or wireless device as a tab per the exemplary FIGS. 5-22. Each tab and its possible contents will now be discussed.

A demographics tab 302 provides query information about patient demographics contained in the practice's database 206. If one wishes to omit a demographic category from a query, the field may be left blank. A first demographic may be age which may be specific, for example, 25, or be provided in an age range such as 20-29. A second demographic is sex: male, female or both may be possible choices. A third demographic in the United States may be zip code (in addition to specific address data)—the zip code or postal code may in combination with other zip codes define a service region. A fourth demographic may be birth date which is practically an equivalent to age. As with age, the birth date may be equated to a range or to a term of art such as “baby-boomer”. Birth date is more specific than age and so is preferable as the record of “age” must be identified with a further date indicating, for example, the date the medical history was taken. A fifth demographic is insurance data which may be already known to the system 201 or entered, if unknown, via a text field. Similarly, a sixth demographic may be insurance group which is an identifier typically appearing on a patient's insurance card. If not known to the system 201, the insurance group code may be entered via a text field. A seventh demographic is the PCP, primary care provider. The PCP may already be known to system 201 and accessible via a more button or entered into a text field. An eighth demographic may be the identity of the referring provider 216 who likewise may be known to the system 201, accessible by a “more” button or added via a text field. A ninth demographic may be the identity of a facility such as an associated hospital which may be accessed from a drop-down menu by an authorized user and their selecting either facility or facility group or using the “more” button or adding an entry via a text field. A typical demographics query may be all patients over 65 years of age for a patient alert via patient portal 212 to receive a flu shot.

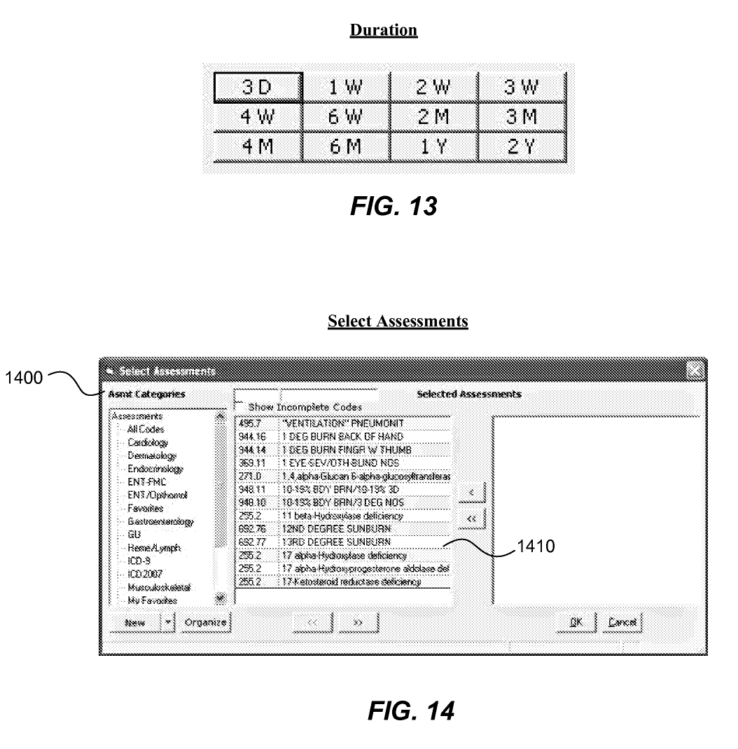

A vitals tab 304 may include, for example, the following data. A first vital may be height, a second weight, a third blood pressure and a fourth heart rate—all of these may be defined as a range or as an exact number and associated with a real time indication via clock 205. A fifth vital may be HC or head circumference as a specific or within a range. (HC is used in pediatrics to determine the progress of development of a child's brain.) A sixth vital may be body temperature which may be given as a specific value on a give date and time or as a range, such as normal. A seventh vital may be BMI or body mass index which can be a specific ratio or identified as a range between low and high. An eighth vital is a date range which can default to the current date. A start and end date can be edited. For example, a query may be constructed for a date range of the last five years while the BMI has exceeded a given value to identify patients that may need dietary advice. See, for example, FIG. 13, for an example of a shorthand computer screen for entering dates and ranges such as 5Y for 5 years. If a practice's database 206 is scheduled to update nightly at 11:00 PM, and a physician member of the practice would like to query the database and include the vitals information gathered from a patient earlier in the day, a migrate vitals button 501 may be provided to migrate current data for use in the query. FIG. 5 shows an exemplary migrate vitals button 501 in proximity to registry functions 502-505 to be described in greater detail later herein.

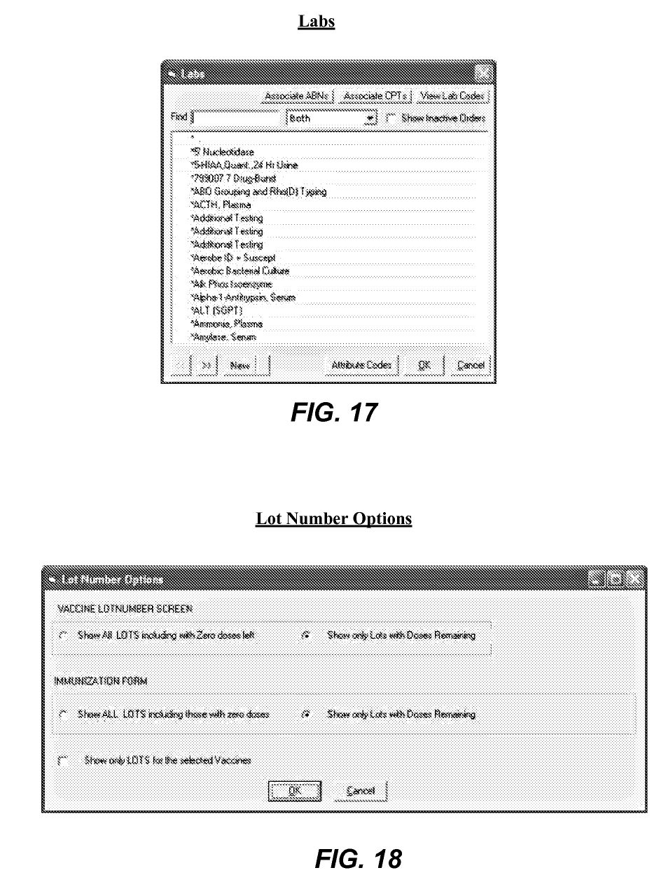

A laboratory tab 306 may be provided with a drop-down list of typical laboratories or a laboratory name may be entered into a labs text field. See FIG. 17 for a typical list of laboratories that may be provided via an exemplary display screen for computer selection. The labs tab allows users to query the database 206 for patients who have been given certain labs. For example, to find all patients with more than one instance of a particular lab (such as blood work for high cholesterol), one may enter a recurrence number in a number of labs field—such as 3 or more CBC (complete blood count) labs. One can also query, for example, labs within a specific date range or for all labs with certain results. See, for example, run new 505 and save queries 502 of FIG. 5 or FIG. 22.

An ICD is a standard diagnostic code for the medical industry. FIG. 14 provides standard ICD codes for assessments. Per FIG. 14, if the physician searches a group such as cardiology category 1400, then, only cardiology assessments will be displayed. An ICD tab 308 may be provided for queries of a particular diagnosis. Because ICD is a standard, the ICD tab may be most easily provided via a drop-down list, for example, a list including 3 ^{rd} degree sunburn 1410. The corresponding assessment for the ICD selected may be displayed. The assessment may be entered via the screen of FIG. 6 at the time of consultation with a patient and input via a wireless LAN. Queries may be run for all patients having a given ICD diagnostic code among other queries. Alternatively, a drop-down list may provide an ICD group such as cardio to identify all heart patients as a group; see FIG. 16.

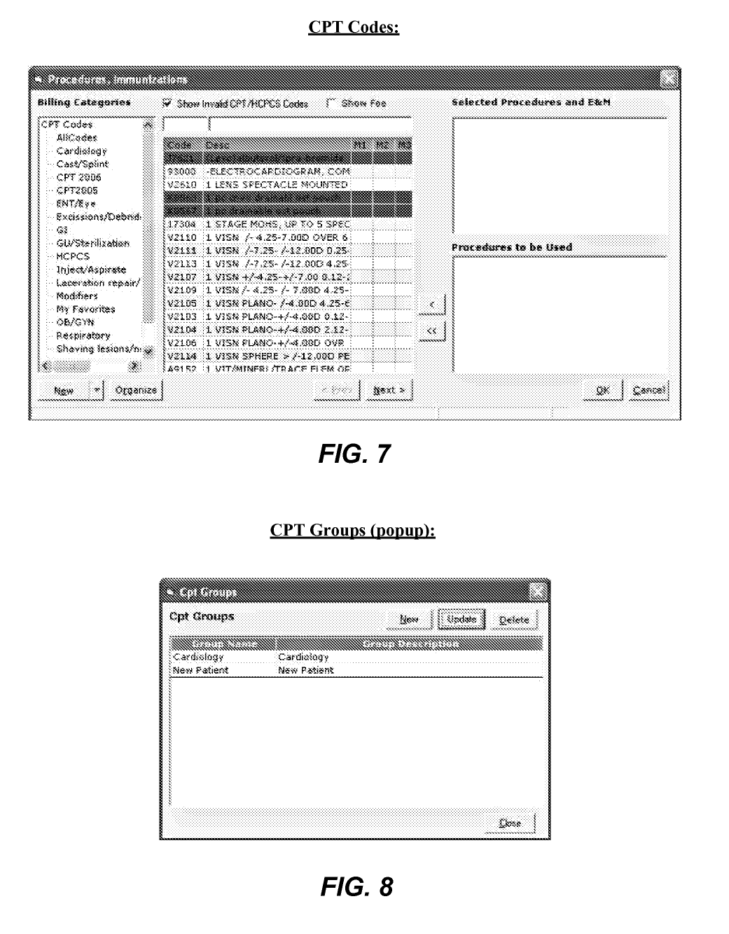

A CPT is a codified procedure term which typically applies to a given diagnosis. CPT codes tab 310 is most conveniently provided as a drop-down list; refer, for example, to FIG. 7 for an exemplary screen shot. Given a CPT code, a corresponding procedure/immunization window may display. Also, for each CPT, there may be a standard fee associated with the procedure and the fee associated with a billing category. Queries may be run for all children in need of a measles vaccination. Similarly to ICD's, CPT's may be provided in groups such as cardiology; refer to FIG. 8. Cardiology is first seen in FIG. 7 as a billing category and once selected, only cardiology CPT codes may be shown in a display window. FIG. 8 shows an association of a group such as cardiology to a new patient to be named. By entering “update” after the new patient's name is entered, the patient is labeled as a cardiology patient.

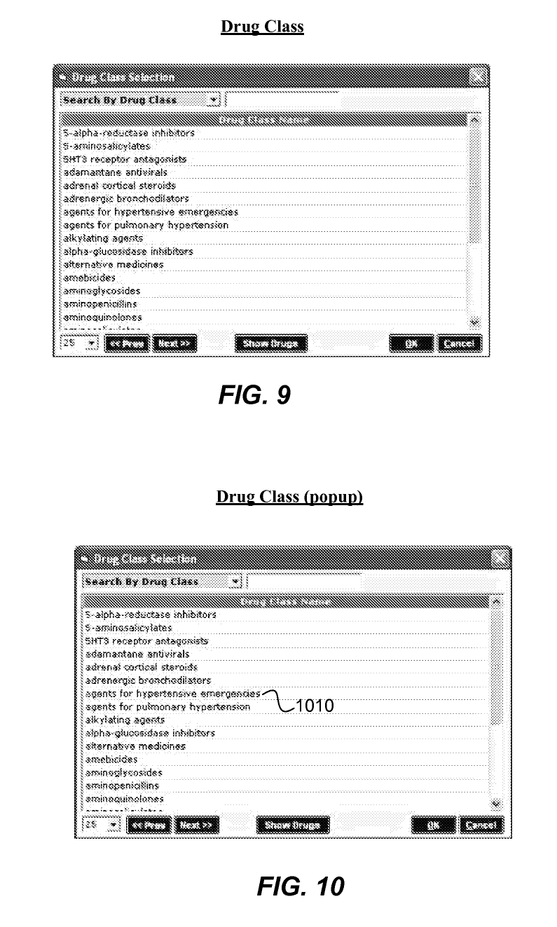

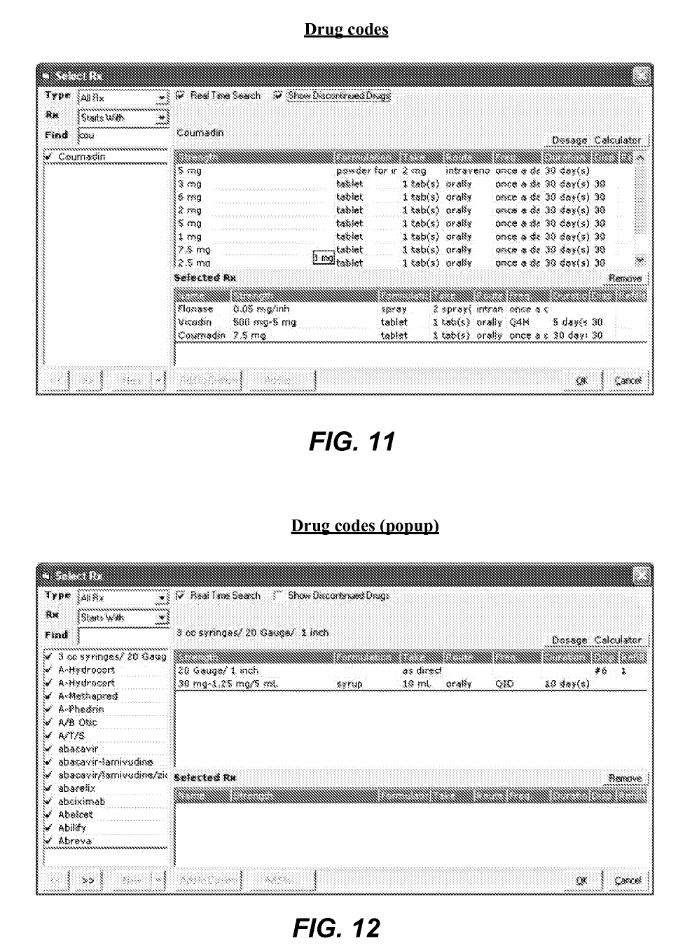

A Rx or prescription tab 312 is provided for standard drug types and name brand and generic identifiers as appropriate. The drug codes may be selected from a drop-down list by type, per exemplary screen shot FIG. 9, or “drug class.” Once a desired drug code is located and selected, for example, from FIG. 11 or 12, the various dosages and formulas related to the chosen category may be displayed. Discontinued drugs may be identified. Queries may be made for patients with prescriptions for a selected drug within a specific date range, for example, to find out what patients are currently taking a given medication. Using “run subset (not)” 503 diabetic patients over 65 not on insulin or using an insulin pump may be queried and identified. Besides drug codes, drug classes may be identified such as, for example, agents for hypertensive emergencies 1010. Thus, queries may be run by specific drug or by class as needed.

An alerts tab 314 signals special situations known to the practice. Alerts may be categorized, then, as protocol alerts so that, for example, all patients given an immunization with treatable side effects may be identified and treated. One may search, for example, based on tests not ordered, tests not ordered and results not received and tests not ordered and results not reviewed. Queries may be constructed within date ranges per FIG. 13.

A medical history tab 316 permits a query for patients with a specific medical condition (for example, an abnormal pap smear 2020). See FIG. 20 for an exemplary screen shot. A window may provide an alphabetical list of such conditions. One may scroll through the list and queries run to identify patients with the condition. Medical history may be displayed as selected for a given patient. A query may be run, for example, for just the word “pap” as needed to locate the desired condition using Find.

An immunization tab 318 may not only contain a common identifier for an immunization such as small pox but also a lot number field to identify a lot used for an immunization in the event of a bad lot. Sequences of immunizations may comprise multiple lots. Lot information may be provided via exemplary screen shot FIG. 18, for example.

An encounters/visits tab 320 permits querying for patients based on encounters/visits dates. A quick date feature may be provided, for example, using shorthand such as 3D for 3 days, or 5W for five weeks or 8M for eight months and 5Y for five years. See exemplary screen shot for FIG. 13. One may query for only office visits and encounters may include recorded telephone calls.

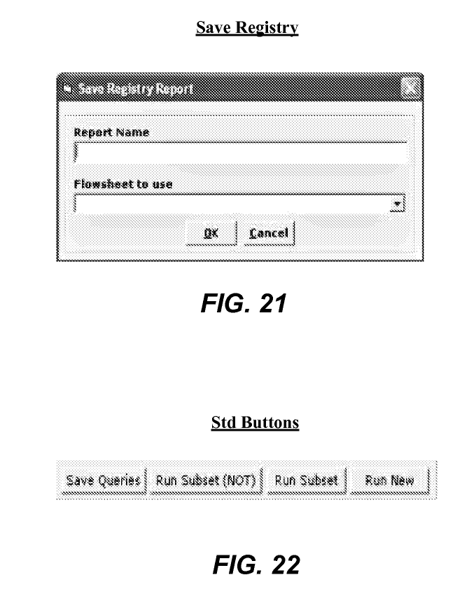

Now the registry functionality will be described comprising: save queries 330, run subset 340, run subset (not) 350 and run new 360 with reference to FIG. 3 and buttons of FIG. 5 or 22. Once a given query is run using a given filter, a save queries 330 function permits one to save a registry report (FIG. 21, for example) with a report name and a flowsheet to use from a drop-down list to select from. Once the Save registry report window of exemplary FIG. 21 displays, one selects the name and flowsheet and may click ok to save the query set. The new report is saved in a registry reports list and may be recalled by clicking an appropriate icon under, for example, a recalls band in a navigation bar for registry reports. See, for example, screen shot 21 for saving a registry report. For example, one may run a given report as an Excel® spreadsheet, and a file created as a comma-separated value (.csv) file.

Thus “save queries” 502 may save all current selections on all filters 302-320 across all tabs. The user may save their query set, name it, and attach a relevant flowsheet. The query may be run again in the future, for example, after a period of time. Run subset 340 (button 504) runs a query on a subset of a previous query using the information selected in the filters on that specific tab. For example, a first query may identify all patients over 65 and a second query may identify those that have had their flu shot. A run subset (not) 350 (button 503) will identify those patients over 65 who have not had their flu shot. Run new 360 runs a new query on the entire database 206 using selected filter options.

Thus, the running of queries may be seen as a set of Boolean operations, especially AND and NOT which may be performed to sequentially identify a population of patients who may be alerted by means of conventional telecommunications, by letter or by patient portal 212 to a need for an appointment, an appointment reminder, a medical alert, an upcoming laboratory or imagery requirement, a course of treatment or remedial efforts.

Now, FIG. 4 will be described in the context of the application of a registry feature of an embodiment of a medical records system 201. Box 400 may represent an electronic medical records (EMR) system registry module as described in accordance with FIG. 3. Box 410 represents a plurality of federal agencies that may be interested in registry functionality. A Center for Disease Control (CDC) 410 a United States federal agency, may request and be provided over a communications link with the results of a series of queries which may be helpful to identify the outbreak of an epidemic in a geographic region of the country. Conversely, the CDC may want to use the communications link to advise a practice of the outbreak of an epidemic and alerts as to the availability of immunization, for example, in the instance of an outbreak in the United States of the aviary flu and the availability of an associated vaccine. Via the patient portal 212 or other patient access such as conventional telecommunications access 214, the patients may be advised of the epidemic breakout, the availability of vaccine and the need to make an appointment with the practice group processing EMR software/hardware system 201 that has been alerted over the link.

A National Institutes of Health (also identified in box 410 as a federal agency) may be interested in a pattern of increase/decrease in a given disease such as cardiac disease or cancer or AIDS. At the state level, for example, the state of Arizona, may be interested in demonstrating that the incidence of asthma or allergies and nasal congestion symptoms may be minimized if one lives in the state of Arizona. Private research organizations 430 and universities, medical colleges and the like may be interested in collecting data from databases 206 for research purposes. Such research groups may wish to identify patients with certain demographics or other characteristics and invite those participants to participate in research projects or try new courses of treatment or drugs under development. These are but a sampling of the possible applications of a registry module of an embodiment of an electronic medical records system 201 as described above. It should be understood that the medical arts should be defined to include the dental arts, the Chinese practice of medicine and other conventional and non-conventional forms of medicine practiced in the United States and throughout the world. Other advantages and features will come to mind of one of ordinary skill in the medical arts from reading the disclosure of the embodiments and the embodiment should only be deemed limited by the scope of the claims that follow.

What I claim is:

1. A logical interface for mining medical data records comprising:
a data processor for receiving input of a selection of criteria for a medical records query;
a database of medical records, responsive to a query, for outputting patient medical record data responsive to the query;
a plurality of operations including a means of combining a first and second query and a means of providing medical data not meeting the first and second query.

2. A logical interface as recited in claim 1 further comprising a patient portal for access by patients, the patient portal for providing medical data to a patient responsive to the first and second query.

3. A logical interface as recited in claim 1 wherein said first or second query comprise querying via a plurality of filters including at least one of demographics, vitals and prescriptions.

4. A logical interface as recited in claim 1 wherein said first or second query comprise querying via a plurality of filters including at least one of prescriptions and immunizations.

5. A logical interface as recited in claim 1 wherein said first or second query comprise querying via a plurality of filters including at least one of an ICD code or a CPT code.

6. A logical interface as recited in claim 1 wherein said first or second query comprise querying via a plurality of filters including at least one of a medical history and encounters/visits.

7. A logical interface as recited in claim 1 further comprising an interface to an external database including one of a federal agency, a state agency and a research organization.

8. A logical interface as recited in claim 7 further comprising a patient portal for access by patients, the patient portal for providing a medical alert input via said interface to an external database.

9. A method of logically interfacing with a medical records database comprising:
selecting a first query via a first filter;
selecting a second query via a second filter;
running a subset combining the first and second queries; and
logically “not” operating on the subset to obtain a set of medical patient data.

10. A method of logically interfacing as recited in claim 9 further comprising:
transmitting a message associated with the set of medical patient data via a patient portal.

11. A method of logical interfacing as recited in claim 9 wherein said first or second query comprise querying via a plurality of filters including at least one of demographics, vitals and prescriptions.

12. A method of logical interfacing as recited in claim 9 wherein said first or second query comprise querying via a plurality of filters including at least one of prescriptions and immunizations.

13. A method of logical interfacing as recited in claim 9 wherein said first or second query comprise querying via a plurality of filters including at least one of an ICD code or a CPT code.

14. A method of logical interfacing as recited in claim 9 wherein said first or second query comprise querying via a plurality of filters including at least one of a medical history and encounters/visits.

15. A method of logical interfacing as recited in claim 9 further comprising interfacing to an external database including one of a federal agency, a state agency and a research organization.

16. A method of logical interfacing as recited in claim 10 further comprising broadcasting a message to all patients identified responsive to a query via said patient portal.

17. Computer readable media for performing the method of claim 9.

18. A system comprising an electronic medical records subsystem and a centralized database, the centralized database collecting medical query result data from at least one subsystem, the centralized database for permitting the generation of a medical alert directed to patients associated with the at least one medical records subsystem responsive to the medical query result data.

19. A system as recited in claim 18 further comprising a patient portal of the electronic records subsystem for providing a personal patient alert.

20. A system as recited in claim 18, the centralized database collecting specific medical query results indicative of symptoms of a particular disease, the electronic medical records subsystem comprising patient symptom data for a plurality of patients.
